(19) United States
(12) Patent Application Publication
(10) Pub. No.: US 2012/0296611 A1
(43) Pub. Date: Nov. 22, 2012

(54) System and Methods for Structure Design, Analysis, and Implementation

(75) Inventors: Eric Teller, San Francisco, CA (US); Nicholas Chim, San Francisco, CA (US); Augusto Roman, Mountain View, CA (US); Jennifer Carlile, San Francisco, CA (US); Alena Fong, Fremont, CA (US); Eli Attia, Palo Alto, CA (US); Michelle Kaufmann, Novato, CA (US)

(73) Assignee: GOOGLE INC., Mountain View, CA (US)

(21) Appl. No.: 13/112,727

(22) Filed: May 20, 2011

(51) Int. Cl. G06F 17/50

(52) U.S. Cl. 703/1

(57) ABSTRACT

A computer-implemented system for designing a structure and coordinating its implementation is disclosed. The system includes a design workspace, a design engine which receives various inputs and produces a structure design for display in the design workspace, a requirements providing structure design requirement rules to the design engine for producing the structure design, and a cell source providing a definition of a cell that forms a portion of the structure design. The cell is configured to be assembled together with other cells to form the structure design. An attributes engine quantifies measures of various attributes of a structure based on the structure design during the process of designing the structure, and displays the quantified measures in a dashboard user interface. Optimization engines for analyzing the structure design, and proposing alternative designs is provided. The design may be optimized for various criteria, including the attributes quantified by the attributes engine.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent fie or records, but otherwise reserves all copyright rights whatsoever.

### BACKGROUND

The present disclosure is related to the design and realization of structures such as buildings, and more specifically to systems and methods for designing, iterating, and building such structures, and supporting the ecosystem of the processes and the parties participating in those operations.

Traditionally, the process of designing and building a structure involves many professionals with many different skill sets. As an example, a developer interested in having a commercial structure built may retain an architect, who takes the developer's requirements and preferences, details about the site, building codes and the like, and first generates a conceptual design, then a more detailed schematic design. At this stage, the architect's role is to synthesize, problem solve, and design. The resulting forms, as drawn and/or modeled, are typically a blending of art and engineering. Reviews and reworking for multiple different audiences typically occur next in what is often referred to as design development. For example, an architectural engineer or similar professional may review the design and plans for the proposed structure's integrity and safety, the developer may have input for modifications to the design to meet a desired design goal, the builder may introduce limitations based on cost, time-to-completion, feasibility, and so on.

Portions of the design may also be sent to sources for cost estimates and to determine availability of elements of the structure, estimates for labor cost and time-to-delivery of components, etc. Estimates from these many other sources may then also be factored into calculated time-to-completion, cost, and so on. Bidding and negotiation may take place, such as with a builder or construction manager, parts and services providers, etc. Further design development then typically takes place to bring the design in line with budgets, evolving design requirements, etc.

Once the final design and plans converge for the main parties of interest (developer, architect, engineer, and builder, who form the core of the ecosystem for the project), required permits and other approvals may then be sought. An additional one or more round(s) of design development take place including negotiations with certifying and permitting agencies in order to converge on a mutually acceptable design. Ultimately, construction begins and in spite of inevitable cost and time overruns a structure is built.

While there are many other steps and parties involved, and the actual order of things may vary from structure to structure, the process is long, convoluted, circular, often unnecessarily complex, with many parties involved, and there are many opportunities for inefficiencies and delays in the various design, interaction, revision, and iteration of the design and build process. Furthermore, for each new structure, the process essentially reinvents itself from scratch, but never the same from one structure to the next. There is little re-use of designs, processes, and data in the design and construction of new structures. And, there are few resources available to improve efficiency and effectiveness in the communication and work processes taking place in the community of people and agencies involved in the design and construction process.

### SUMMARY

Accordingly, the present disclosure is directed to systems and methods for more efficiently designing a structure and facilitating its implementation than heretofore possible. The systems and methods disclosed permit a degree of automation to fitting a design to a site at which it is to be constructed, taking into account data about the site, applicable building codes and practices, zoning, design preferences, and other system inputs. Design optimization provides design refinement to meet various design targets. Direct feedback of relevant data is made easily accessible throughout the process.

According to aspects of the disclosure, interfaces to the system are provided to permit design data to be provided to secondary systems for analysis, design refinements, further optimization, and certification analysis, and permit collaborative design processes. Interfaces to the system are also provided to permit others in the design and build ecosystem to collaboratively contribute to the design. Additional interfaces are also provided to permit the system to both receive and deliver complete building documents, prerequisite certifications, and other materials required to initiate the build phase for a structure.

According to one aspect of the disclosure, the system facilitates a close working relationship between various parties involved in designing and implementing a structure. Vendors of systems and components provide data relating to elements they provide, their cost, availability and so on, which may be used during the design process. Similarly, service providers provide data relating to cost, timing, etc. of services they provide such that that data may be factored into attributes of the design.

According to another aspect of the disclosure, a design may utilize portions or all of prior designs, system and component data, service provider data, and other elements to provide improved efficiency to the design process. A variety of interfaces are provided to the user to permit viewing and selection of elements for the design, visualizing the design in process, and editing the design.

Accordingly, a computer-implemented system for designing a structure and coordinating its implementation is provided which comprises: a design workspace in which a structure design can be rendered during a design process; a design engine which receives various inputs and produces a structure design for display in the design workspace; a requirements source coupled to the design engine and containing a structure design requirement rule, the design engine utilizing the structure design requirement rule as an input for producing the structure design; a cell source coupled to the design engine for providing a definition of a cell for forming a portion of the structure design, the cell configured to be positioned together with other cells to express the structure's form, the design engine utilizing the cell definition and its arrangement as an input for producing the structure design; an attributes engine which quantifies measures of various attributes of a structure based on the structure design during the process of designing the structure; and, a dashboard for displaying the measures of various attributes of the structure during the process of designing the structure.

According to a still further aspect of the disclosure, optimization engines for configuring the structure design and definitions of cells comprising the design, and proposing alternatives to the design are provided. The design may be optimized for various criteria, including the attributes quantified by the attributes engine.

The above is a summary of a number of the unique aspects, features, and advantages of the present disclosure. However, this summary is not exhaustive. Thus, these and other aspects, features, and advantages of the present disclosure will become more apparent from the following detailed description and the appended drawings, when considered in light of the claims provided herein.

### BRIEF DESCRIPTION OF THE DRAWINGS

In the drawings appended hereto like reference numerals denote like elements between the various drawings. While illustrative, the drawings are not drawn to scale. In the drawings:

FIG. 1 is a high-level representation of a distributed network environment, comprising hardware and software, within which various embodiments of a system for structure design, analysis, and implementation according to the present disclosure may be employed.

FIG. 2 is a schematic diagram of a portion of a first embodiment of a computer-implemented system for structure design, analysis, and implementation according to the present disclosure.

FIGS. 3A and 3B are perspective views of two instances of cells, prior to and following the bringing together of those two instances, respectively, according to the present disclosure.

FIG. 4 is an illustration of one embodiment of a cell data database that includes or accesses a rules library for providing cell definition rules in a system according to the present disclosure.

FIG. 5 is an illustration of one embodiment of an external data database configured to receive data from a number of sources external to the system for structure design and analysis according to the present disclosure.

FIG. 6 is a perspective view of an exemplary structure design showing cell instances and systems of a type produced by a system according to the present disclosure.

FIG. 7 is an example of a user interface within which a user may view and edit a design, view various attributes of the design in a dashboard, and view other aspects of the design and processes according to the present disclosure.

FIG. 8 is an example of a user interface in which a user-controlled selection process for structure design optimization and preference selection according to the present disclosure is illustrated.

FIG. 9 is an example of a user interface in which a side-by-side comparison of two design options can be made according to the present disclosure.

FIG. 10 is an example of a user interface in which one of a plurality of design versions can be selected and reviewed according to the present disclosure.

FIG. 11 is an illustration of one embodiment of an elements data database configured to receive data from a number of sources according to the present disclosure.

FIG. 12 is an illustration of one embodiment of an export engine for providing various details of a structure design to entities external to the system for structure design and analysis according to the present disclosure.

### DETAILED DESCRIPTION

We initially point out that description of well-known processes, components, equipment, and other well-known details are merely summarized or are omitted so as not to unnecessarily obscure the details of the present invention. Thus, where details are otherwise well known, we leave it to the application of the present disclosure and the knowledge and ability of one skilled in the art to suggest or dictate choices relating to those details.

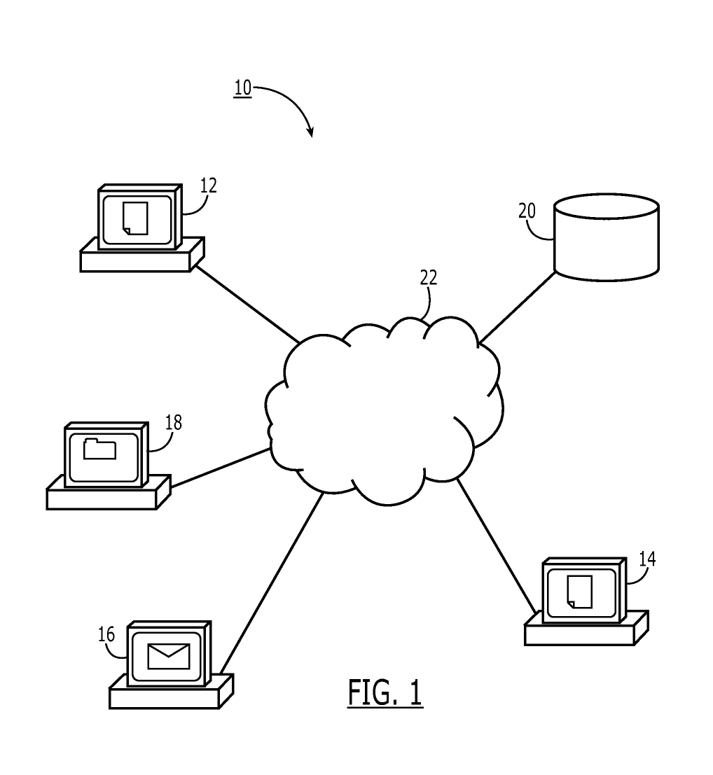

With reference initially to FIG. 1, a distributed network environment 10 is shown, comprising hardware and software, within which various embodiments of the present disclosure may be employed. More specifically, distributed network environment 10 comprises multiple interconnected elements of hardware, each running software, allowing those elements of hardware to communicate with one another, whether by wired or wireless connection. Such elements of hardware include, but are not limited to, a first client workstation 12, a second client workstation 14, a mail server computer 16, a file server computer 18, and network appliances 20 such as remote storage, each communicating via the public Internet 22. Alternatives to using the public Internet, or additional interconnection mechanisms include local area networks (LANs), wide area networks (WANs), etc. Alternatives to client workstations, or additional computer mechanisms include personal computers, servers that are personal computers, minicomputers, personal digital assistants (PDAs), cell phone-based computers, mainframes, etc. The network within which the various embodiments of the present disclosure operates may also comprise additional or fewer devices without affecting the scope of the present disclosure.

First and second client workstations 12, 14 may communicate via the public Internet 22 using known Web browser software or dedicated, specific-purpose application software. As is well known, software components supporting client workstations 12, 14, servers 16, 18, and network appliances 20 include or reference logic and/or data that may form a part of the software component or be embodied in or retrievable from some other hardware of software device or signal, either local or remote and coupled via a network or other data communications device.

Thus, embodiments of the invention may be implemented as methods, apparatus, or articles of manufacture as or in software, firmware, hardware, or any combination thereof. As used herein, article of manufacture (or alternatively, computer program product) is intended to encompass logic and/or data accessible from any computer-readable device, carrier, or media.

Those skilled in the art will recognize many modifications may be made to this exemplary environment without departing from the scope of the present disclosure. For example, it will be appreciated that aspects of the present disclosure are not dependent upon data structure formats, communications protocols, file types, operating systems, database management system, or peripheral device specifics. Accordingly, the following description is provided without reference to specific operating systems, protocols, or formats, with the understanding that one skilled in the art will readily be able to apply this disclosure to a system and format of choice.

The present disclosure provides a computer-implemented system and methods for producing a design of a structure and coordinating aspects of its implementation. As used herein, a “structure” may be, but is not limited to, habitable buildings, functional structures, artistic structures, and so on, and the nature of the structure does not form a limitation on the scope of the present disclosure. Furthermore, as used herein, “designing” is intended to mean all aspects of preparing plans for implementing a structure, including but not limited to developing a set of documents that describe a structure and aspects of its construction, as well as estimates relating to the design and construction of the structure. Designing a structure may optionally include the materials for and processes of obtaining prerequisite certifications and approvals for constructing the designed structure. Still further as used herein, “implementation” is intended to mean verifying aspects of a design, arranging accessibility to required parts, services, and personnel, maintaining a project timeline, maintaining a project budget, managing changes during the build phase, financing and insurance, and constructing the structure. Optionally, implementation may also include coordinating and obtaining approvals, permits, and the like.

According to the present disclosure, a user interacts with a computer system and controls provided thereby to design a structure. In the process, the system may communicate with other systems to obtain data, verify data, deliver data, store or retrieve data, etc. Those other systems may be interfaces to other computer-user interactions or be autonomous or some combination of the two. As used herein, “interface” is intended to include data structures, virtual and physical connections between devices, computer-human user interface, and other mechanisms that facilitate the exchange of data between computer system and/or control of one or more such systems. In one embodiment, an interface requires a minimum or no user data entry or manual delivery of data from one system to another. In another embodiment, data that needs to be entered manually may be retained and reused within the system, reducing future data entry requirements.

In general, a method of designing a structure employing a system of the type disclosed herein begins with a user specifying a program (general aspects of the structure and its intended uses), which may be translated into requirements of the design. Given certain starting conditions, such as a description of the site on which the structure is to be built, a structure footprint (or equivalently, perimeter), the basic intended use of the structure, and so forth, the system may provide a proposed initial design, and self-iterate toward meeting the design requirements. Alternatively, the user may select “cells” and/or other elements from a palette (or specially designed) and manipulate those elements in a design workspace to populate a structure design.

According to the present disclosure, a cell is a fundamental element employed by the system and user to design a structure. Cells are abstractions of portions of a structure (although in certain cases a structure may in fact be comprised of a single cell) upon which other systems in the design depend. Cells are instantiated as part of the design process. Cells include rules governing aspects of the instantiations, such as how an instance of one cell connects to another instance, size ranges of instances, systems or components included in or required by an instance, and so on. Cells are discussed in further detail below.

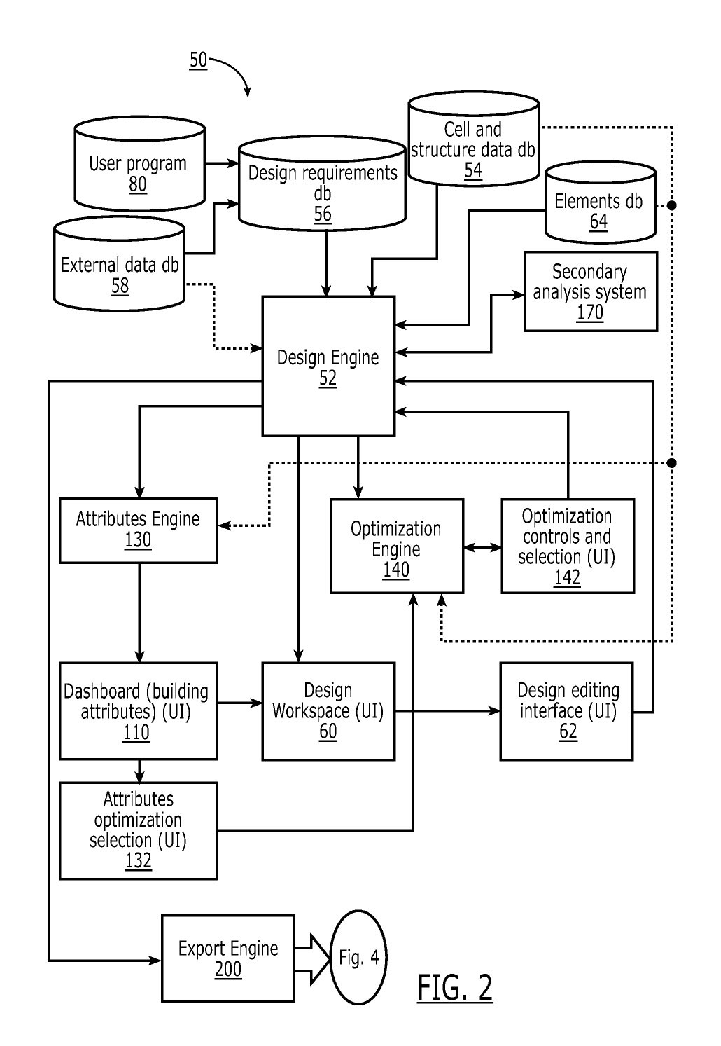

Referring to FIG. 2, there is shown therein a schematic diagram of a portion of a first embodiment of a computer-implemented system 50 for designing a structure and coordinating its implementation according to the present disclosure. Embodiment 50 comprises a design engine 52 that manages aspects of the structure design process. Design engine 52 may be realized in software, firmware, hardware, etc.

Design engine 52 receives various inputs including data from cell and structure data database 54, design requirements database 56, and optionally external content database 58 and elements database 64 interconnected thereto. While these data inputs are shown and discussed in terms of databases, it will be appreciated that other forms of data input, such as streaming data, real-time measurement data, calculated data, etc. may also be employed.

Design engine 52 provides an output in the form of data representing a structure that is rendered in a design workspace user interface (UI) 60. Design engine 52 may include rendering capabilities, or may rely on additional tools, such as Google SketchUp to perform rendering tasks. Design workspace UI 60 provides a user with a visual representation of the structure being designed, as well as a design-editing interface 62 at which a user may edit the design.

Cell and structure data database 54 may provide a set of generic rules that are used by design engine 52 for populating the structure footprint. These rules may be explicit or may be derived algorithmically. In one example, a rule might be that, all other things being equal, the secondary beams in each cell should run in the same directions as their neighboring cells. Another example might be that each cell has support structures (columns) in appropriate places within it, but when two cells are placed together, they abandon their redundant structure and each includes the shared columns and beams at their intersection (with the redundant material been removed from the design).

Certain aspects of a cell may be specified by these rules, while other aspects may be applied by design engine 52 when implementing the rules. For example, a rule may specify how the cell interacts with other cells in the design, such as how utilities (e.g., HVAC, electricity, water, data, and so on) are passed from one cell to the next. A rule may specify a size component (e.g., a dimension range for instances of a cell), a shape of cell (e.g., straight or rounded sides), a structural members component (e.g., how and where structural members such as columns are located), an interconnection component (e.g., where a cell may connect to another cell), a supplier identification component (e.g., specific suppliers for elements of the cell), an availability component (e.g., are elements specified in the cell readily available or do they take a longer than normal time to obtain), a cost component (e.g., what is the total cost of the elements specified for the cell), a health component (e.g., what level of exposure to specified substances will an occupant of a structure defined by the cell experience), an environmental efficiency component (e.g., energy use per cell), and so on. While some aspects of the cell may be rigidly defined by these rules, others may be adjusted to fit the design. For example, a cell may have a size range as opposed to an absolute size, allowing the system to choose a cell having a size range appropriate for the location.

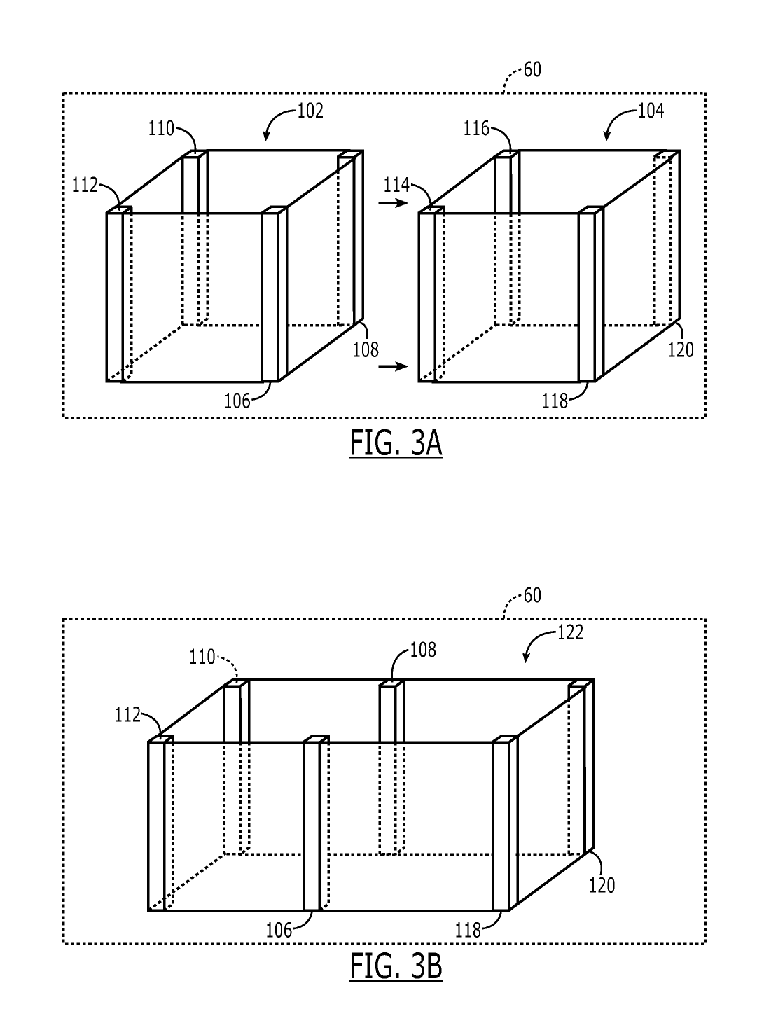

The rules provided by cell and structure data database 54 may have structural aspects, which are interpreted by design engine 52 to develop the structure. For example, one set of rules may require that a cell be supported at its corners by columns. In populating the footprint, two cells placed side-by-side may each be defined by such a rule. This is illustrated for cells 102, 104 in FIG. 3A. Cell 102 initially (at least conceptually) is provided with pillars 106, 108, 110, and 112. Similarly, cell 104 is provided with pillars 114, 116, 118, and 120. When assembled together by design engine 52 cells 102 and 104 are combined together into cell combination 122 (two adjacent cells) shown in FIG. 3B. In the process, it is determined that pillars 106 and 114 would be structurally redundant. Similarly, it is determined that pillars 108 and 116 would be redundant. Design engine 52 then executes a rule resulting in removal of one set of the redundant pillars from the design, leaving the other to adequately support the structure. Alternatively, all redundant pillars may be removed and replaced by new structural members suited to support the instance of the new cell (e.g., larger columns replace each of columns 106, 108, 114, and 116). This is implemented by design engine 52 and rendered in design workspace 60, for example as illustrated in FIG. 3B, in which cells 102 and 104 have been combined into new cell 122, and further in which pillars 114 and 116 have been removed, leaving pillars 106 and 108 as supports in the new cell structure. As definitions, cells carry with them the rules that govern how they connect to one another, how they affect the structure when making those connections, and so on. Many other such rules, such as rules governing conduits and connections for water, air, electricity, data and voice, and the like, are provided by cell data database 54 to permit a relatively complete and efficient population of the structure.

Following the connection of instances of cells, redundant components may no longer be visible in the design as rendered. Indeed, the details of the original cell instances may not be visible. However, the system maintains all such rules and cell identities so that if, for example, the design is modified such as by replacing an adjacent cell instance with an instance of a different cell or an adjacent instance of a cell is removed, the original instance of the cell may be recovered and its underlying data made available to facilitate alternate connections or to stand alone, so that ultimately the design is flexible yet functional during the design process.

Importantly, by developing the design from rules as opposed to individual pre-defined cells, a much wider variety of structure footprints can be accommodated, and a much wider range of designs produced. For example, rather than being limited to specific cell widths, as might be the case when choosing from a library of pre-defined cells, cell width can be determined dynamically to most efficiently and appropriated populate a structure footprint.

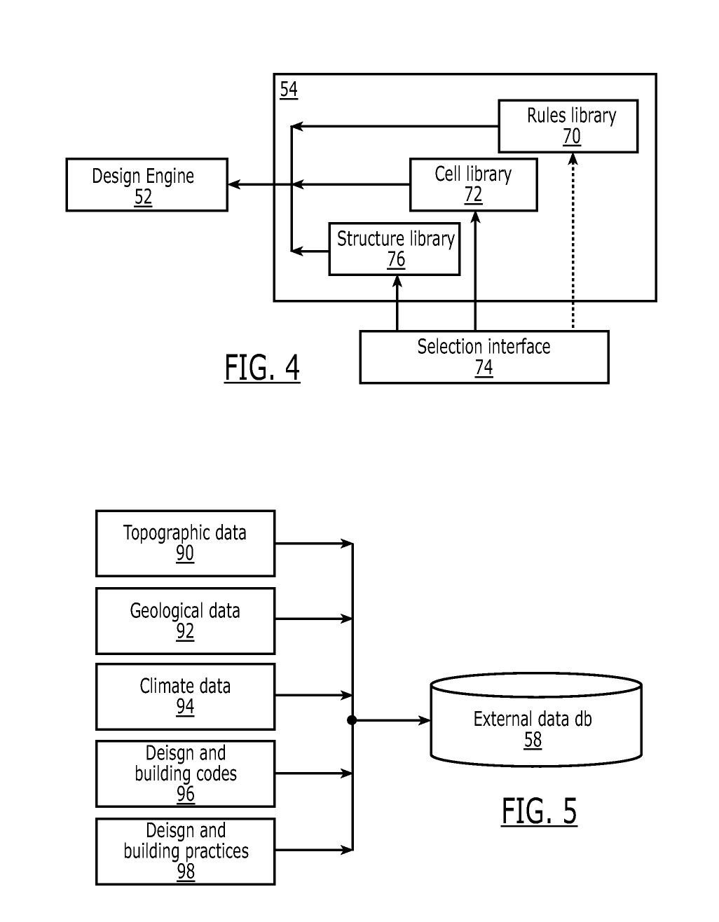

While initially defining cells in terms of the system picking and placing cells to develop a structure design, a user-accessible palette of pre-defined cell designs may also be provided and utilized by a user essentially as building blocks together with or as an alternative to the autonomous pick-and-place process. FIG. 4 is an illustration of one embodiment of cell and structure data database 54 illustrating this point. Cell and structure data database 54 includes or accesses a rules library 70 for providing cell definition rules as previously described. In addition, database 54 may include or access a cell library 72 that provides a number of pre-established cell definitions and/or a resource for editing cell definitions and defining new cells. A user may access cell library 72 through a selection interface 74 or by other user interface to database 54. In addition to accessing and selecting cell definitions, cell and structure data database 54 may provide or access a structure library 76 which includes a number of pre-established partial or complete structures (e.g., buildings or parts thereof) which may form the a basis for at least part of the design produced by design engine 52. A user may access structure library 76 through selection interface 74 or by other user interface to cell and structure data database 54.

Returning to FIG. 2, design requirements database 56 is a library of rules governing aspects of the structure being designed. These rules are selected based upon a specified user program, which may be defined or selected from a user program memory 80. Examples of user programs include, merely as examples, multi-unit residences, multi-unit office space, commercial manufacturing, commercial special uses such as restaurant, library, theater or concert hall, hospital, warehouse, data centers, architectural sculpture, etc. A user may also be provided with an interface (not shown) to modify stored programs and/or develop custom programs. The identification of a user program results in appropriate rules being selected from design requirements database 56 to be provided to design engine 52. The rules provided represent at least a minimum set of structure characteristics that design engine 52 will implement in the structure design. Many opportunities are provided to the user to edit and refine the design, as discussed further below. However, in one embodiment of the present disclosure, design engine 52 seeks to provide as complete an initial design as possible with a minimum amount of user input. This initial design may be accepted, edited in many ways, or scrapped in its entirety and either design engine 52 develops another, different design. In addition, a user interface may be provided for specifying design elements around which design engine 52 assembles a structure design.

Design requirements database 56 may also provide design engine 52 with rules driven by certain external data provided by external data database 58. FIG. 5 illustrates a number of representative sources of this external data. For example, one initial phase of design development is a topographic study of the site on which the structure is to be erected. Data 90 from this topographic study may be utilized by design requirements database 56 to provide rules for design engine 52. Similarly, geologic data 92 required to determine the nature of the soil, bedrock, water table, etc. and climate data 94 relating to averages and ranges of temperatures, rain and snow fall, wind speeds, and so on, which all factor into structure design may be utilized by design requirements database 56 to provide input to the rules for the design engine 52.

In addition to physical and environmental data, a wide variety of design and building codes 96 may suggest or require design rules be implemented by design engine 52. Similarly, generally accepted design and building practices 98 may also suggest or require design rules be implemented by design engine 52. Other external data include zoning data, historical real estate data, neighborhood information (key services, pedestrian and vehicular traffic flow), physical form of neighboring buildings, etc. Means for accessing these design and building codes and practices, zoning data, historical real estate data, neighborhood information, physical form of neighboring buildings and so on, and the format in which they are provided to design engine 52, are beyond the scope of the present disclosure. The relevant point here is that they form examples illustrating the breadth of external data that may be used by design engine 52 to generate a structure design.

In addition to creating the form (i.e., outline or exterior shape) of the design utilizing rules provided by cell data database 54, design engine 52 may populate the design with systems and components from elements database 64. As described in further detail below, systems and components are elements of the design relating to the workings of the structure, mobility of occupants in the structure, and other mechanical and aesthetic elements within (and possibly external to) the form of the design. Examples include, but are not limited to, elevators, stairs, plumbing, electrical, HVAC, and data connections, doors, windows, and so on. Design engine 52 may operate according to rules provided by cell and structure data database 54 and/or design requirements database 56 to select systems and components from elements database 64 when populating the design.

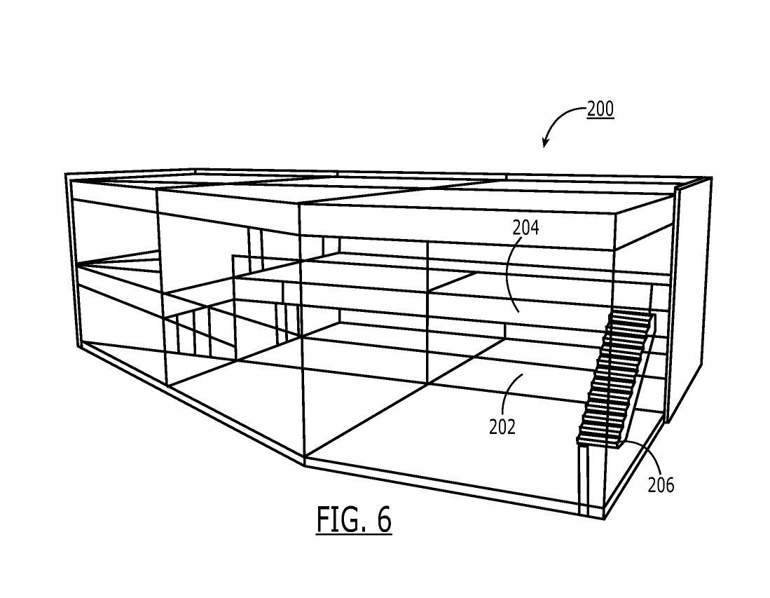

We next briefly outline details of a design produced by design engine 52 in order to provide a reference for the elements of the design and a description of the refinement and editing of such a design. Design engine 52 ultimately generates a structure design, which may for example be rendered in design workspace 60. FIG. 6 is an example of a structure design 200, which for purposes of illustration is a commercial retail space. Design 200 is comprised of a form, which is essentially the outline or shell of the structure, as well as a number of instances of cells, which have been differentiated based on their placement and function within design 200. For example, to form cell instances 202, 204 the design engine used rules from the cell and structure data database. Cell instance 202 has characteristics determined by it being on the ground floor, such as characteristics relating to interfacing with a “basement”, and so on. Cell instance 204, located above cell instance 202, has at least roughly the same floor plan shape and dimensions, but will have different characteristics given that it interfaces with a roof of the structure. However, each of cell instances 202 and 204 may have started from a common cell, or set of rules.

Design 200 also includes a number of non cell-based elements referred to as systems. Stairs 206 are an example of such a system. Systems are themselves comprised of components. The actual treads, risers, railings, balusters, and other elements comprising the stair system, columns, beams, and so on are examples of components. Components may be discrete parts or assemblies of parts. Similar to the manner in which rules result in the instantiation of cells to form the design, rules may also suggest or mandate the location, number, and other specifics of systems and components in a design.

During the design phase of a project, the structure produced by design engine 52 evolves in an effort to meet the various requirements of the interested parties. This design evolution is achieved by: (1) design engine 52 implementing the aforementioned rules; (2) user edits and other manual design control provided by way of user design editing interface 62; (3) various optimizations; and, (4) inputs from various secondary analysis system. Rules have been discussed above. Each of the remaining elements is discussed following.

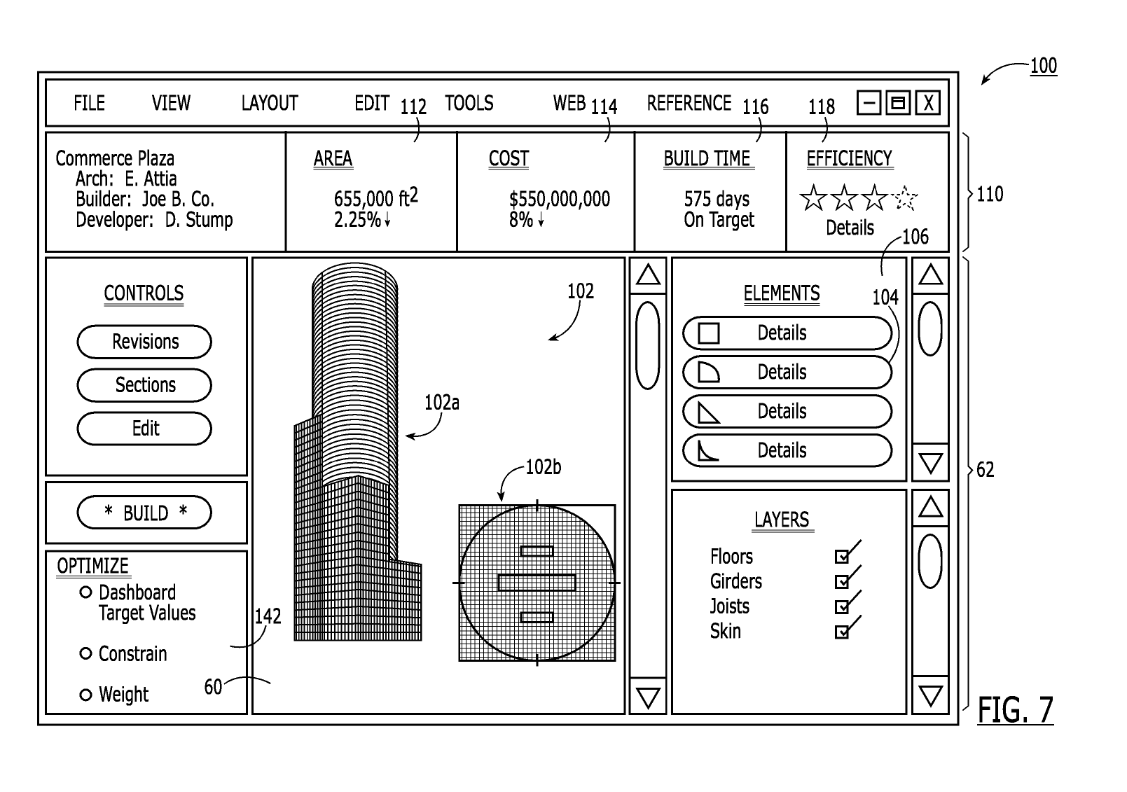

FIG. 7 is an example of a graphical user interface (UI) 100 facilitating user edits and other manual control of a design 102 according to an embodiment of the present disclosure. UI 100 comprises, inter alia, a design workspace 60 and various elements of design editing interface 62. It will be appreciated that elements of design editing interface 62 in addition to those illustrated in FIG. 7 may reside in nested levels that become visible and active given certain user selections. Importantly, a user may interact with design 102 in design workspace 60 through such a UI. Many aspect of the design may be edited, with design engine 52 revising the design to accommodate those edits. These include dragging and dropping new cells, systems or components into the design, deleting cells, systems or components from the design, and rearranging cells, systems or components in the design. Furthermore, the initial footprint of the design may be changed, such as by dragging portions of the footprint view 102b, and the flexibility of the rules-based cells and availability of design requirements permits design engine 52 to modify the design to accommodate the new site footprint.

Elements may be grouped in various ways. For example, while Individual cells, systems or components may be selected for placement, relocating, editing, or removal, the placement, relocating, editing or removal may be performed on a group of cells, systems, or components. Groupings of elements may be based on proximity or adjacency, such as selection of a portion of a structure formed by a contiguous group of cells, or may be conceptual, such as selection of all stairways, beams or the like. So, for example, it is possible to place a series of cells to form a floor plan, group those cells, copy that group, and then stack up copies of the group on top of another. In addition, attributes of a group may be changed, as a group. For example, the glazing of grouped exterior cells can be changed in one step rather than having to make such a change for each cell one at a time.

In one example, a user may add a structure section or system to design 102 by dragging an appropriate element 104 from an elements palette 106 into design 102. These elements may be cell instances, systems, or components. (This drag-and-drop process may also form a preliminary step in the process of design engine 52 developing a design, thereby allowing a user to specify that certain elements form a part of the design produced by design engine 52.)

When modifying the footprint or space configuration of a structure, such elements will typically be cell instances. When adding detail to the interior or exterior of a structure, these elements will typically be systems or components. Editing in this fashion is typically performed in the plan view of design 102, but need not be so limited. This “drag-and-drop” action will be interpreted by design engine 52, which will rearrange cell instantiations, rework shared elements and interconnections, retest the design against design requirements, and so on in an effort to produce a new design with the selected element placed as specified by the user. Many other user editing and manual design controls may be provided by interface 100, such as for removing portions of a design, reshaping or resizing portions of a design, copying portions of a design, and so on.

UI 100 may provide a display region, referred to as dashboard 110 in which various quantified attributes of the structure may be displayed to provide user feedback. While shown as part of UI 100, dashboard 110 may be provided as a separate UI or part of a different UI forming a part of the system disclosed herein. Dashboard 110 may provide a calculated square footage 112, total cost 114, time-to-completion 116, energy efficiency, 118, and so on. In addition to, or as an alternative to providing these and other attributes for the complete structure, dashboard 110 can provide a user with these attributes and others for selected portions of a structure (not shown).

With reference again to FIG. 2, an attributes engine 130 receives design data from design engine 52. This includes data about the form, cells, system, and components of the design from cell and structure data database 54 and elements database 64. Attributes engine 130 calculates the various attributes from this data, and provides those calculated attributes to be displayed in the dashboard 110. While certain attributes of the structure being designed may be determined from the rules of an individual cell, other attributes may only be determined when evaluating the entire structure (or at least only accurately determined). This is a consequence of the fact that a cell definition may be instantiated as many different cells by the many rules being invoked, and only after instantiation and assembly of cells can attributes such as cost, square footage, energy efficiency, and so on be determined.

As described to this point, system 50 has either autonomously or with user input created a structure design which seeks to comply with rules governing the design, such as rules related to stability, safety, building codes, and so on. In addition, system 50 may be configured to optimize the design against various metrics. In one embodiment, a user may specify target values for attribute in a user interface 132, such as but not limited to the attributes shown in dashboard 110, which form targets for design optimization.

An optimization engine 140 receives design data from design engine 52 (optionally together with targets and other optimization selections from UI 132) and modifies aspects of the design, such as by using alternate cells rules, systems or components, changing the form or footprint of the design, reorienting the design on the building site, and so on. It then tests the design to determine if the modification produces an improved design against the optimization metrics. The modify-and-test process continues and improved designs are saved and further optimized, which those that are generally not improved are not retained. In addition or as an alternative to the modify-and-test process, one or more of many different optimization methods may be employed (e.g., linear regression, Simplex method, prune-and-search, etc.) when seeking to optimize a design, and measures are taken to ensure that the optimization routine is convergent. Iteratively, the optimized designs may be rendered in design workspace 60, and the attribute measures provided in dashboard 110 updated.

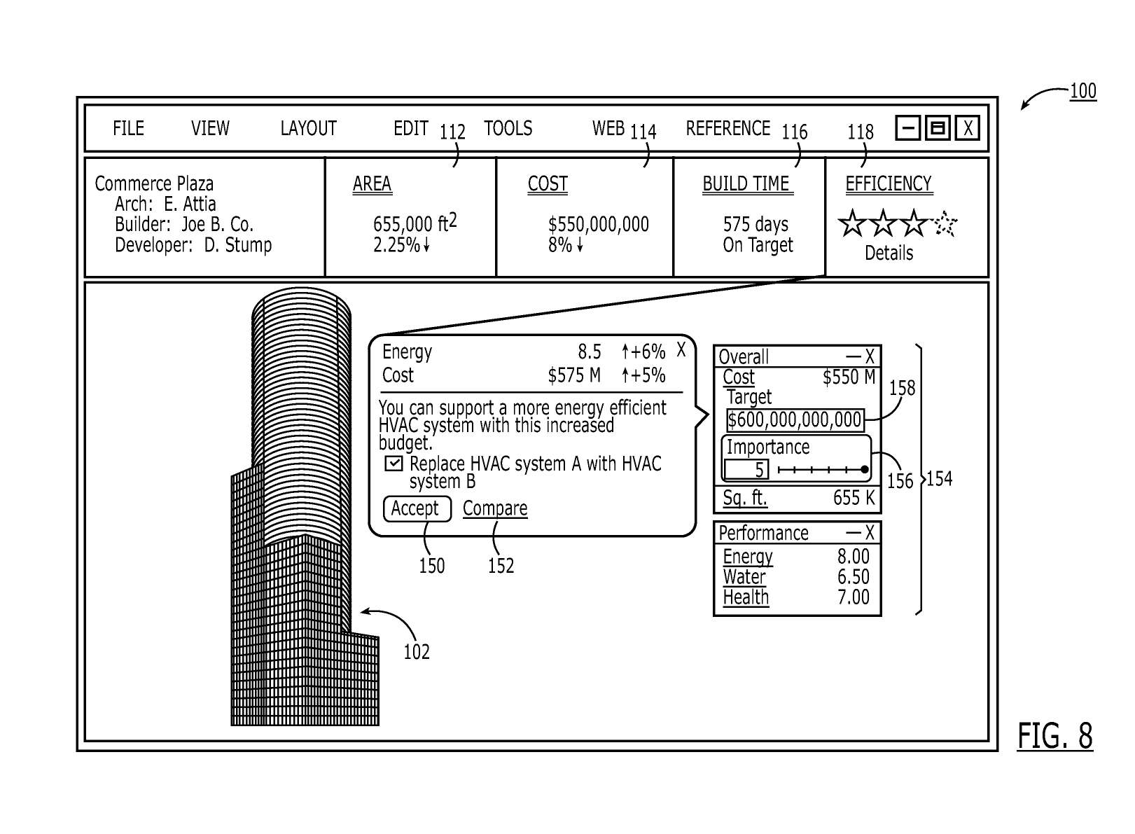

With reference to FIG. 8, a user-controlled selection process for an optimization is illustrated. In this example, system 50 has determined that an improvement in energy cost could be obtained if a more energy efficient HVAC system is selected. In the following the HVAC system serves as an example of a optimization branch point. However, it will be understood that this is merely an example and that virtually all design, system, and component choices may similarly be an object for optimization, with similar selection options, user interfaces, and the like.

Initially, the option of choosing HVAC system B over HVAC system A in order to optimize efficiency is determined by comparing those HVAC systems provided in elements database 64 of FIG. 2. Such systems have been vetted for use by system 50 according to various criteria discussed elsewhere, and availability, cost, compatibility and other factors are considered when evaluating use in the design. Optimization engine 140 takes into account the design data from design engine 52 as well as data regarding selected systems and components from elements database 64 to determine whether optimization options are available and what is to be presented to a user at optimization controls and selection interface 142.

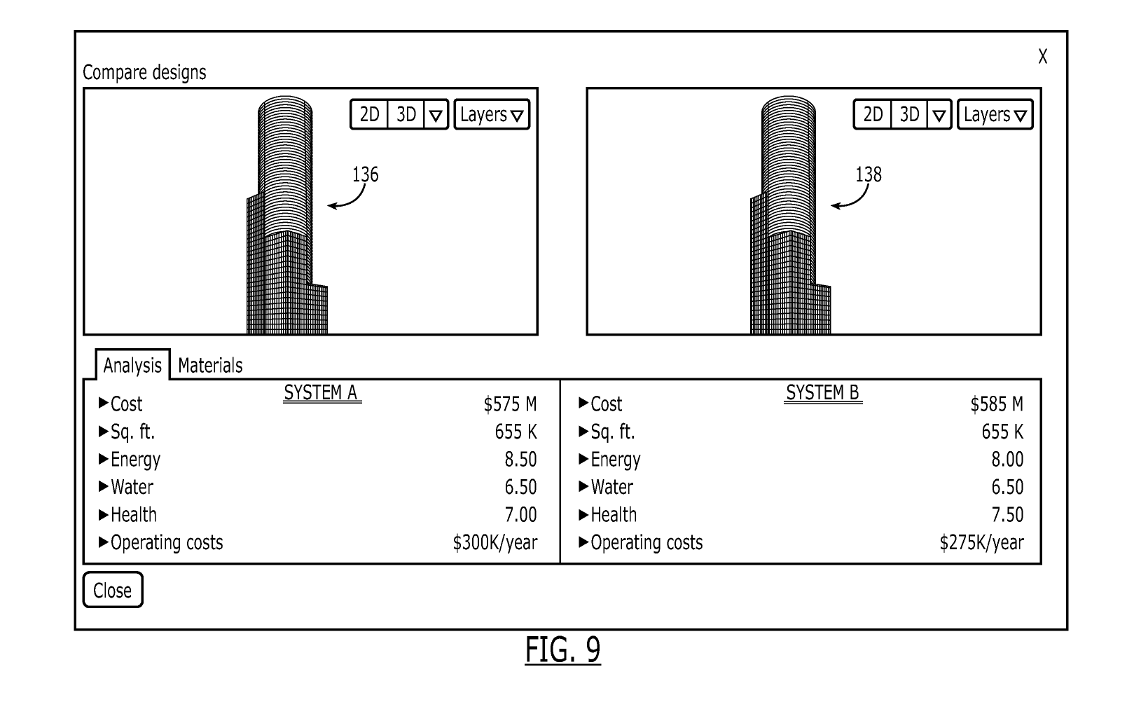

System 50 may be configured to automatically make the selection of HVAC system B over HVAC system A. However, and returning to FIG. 8, system 50 may also be configured to provide the user with an option to select 150 or not select 152 HVAC system B. Summary information regarding the impact of the proposed substitution of HVAC systems on other attributes, such as cost, is provided at 154, to assist with the decision between HVAC system A or system B. System 50 may also provide the user with an interface to examine the option in more detail, and specifically how one HVAC system compares to another in the overall design. An example of such a comparison interface is illustrated in FIG. 9.

In certain design programs it may be desired to restrict elements that system 50 can change in the optimization process. For example, a user may wish to retain a round footprint, a certain curtain wall design, and so on, and have system 50 try to optimize the design by changing other aspects of the design. An optimization controls and selection user interface 142 is provided to permit the user to make such restriction selections.

In addition, it may be desirable to optimize for several aspects of the structure, even when such aspects are potentially competing considerations, such as most square feet and least cost, most window surface area and highest energy efficiency, and so on. In these cases a user may be provided with controls to select preferences or weight aspects around which optimization takes place. An importance slider control 156 is illustrated in summary window 154 of FIG. 8 as one example of user-specified weighting control for aspects of the design. Threshold values, weighted variables, and other multivariable optimization techniques known in the art may be employed to test for optimization in such cases. Indeed, a user interface of the present disclosure may direct optimization engine 140 to optimize for a single attribute or set of attributes over all other attributes, as appropriate for a specific implementation of the present disclosure.

Also shown in FIG. 8, as part of summary window 154, but which can equally be part of another user interface element, is a target value interface 158 in which a user may enter a target value for an aspect of the design, target total structure cost in the case illustrated. Such targets may be the aspects of the design reflected in dashboard 110 (FIG. 7) or other aspects of the design. Entering target values for aspects of the design permits the system to display how the design compares to those target values (such as in dashboard 110, FIG. 7), as well as allowing the system to optimize the design to meet the targets.

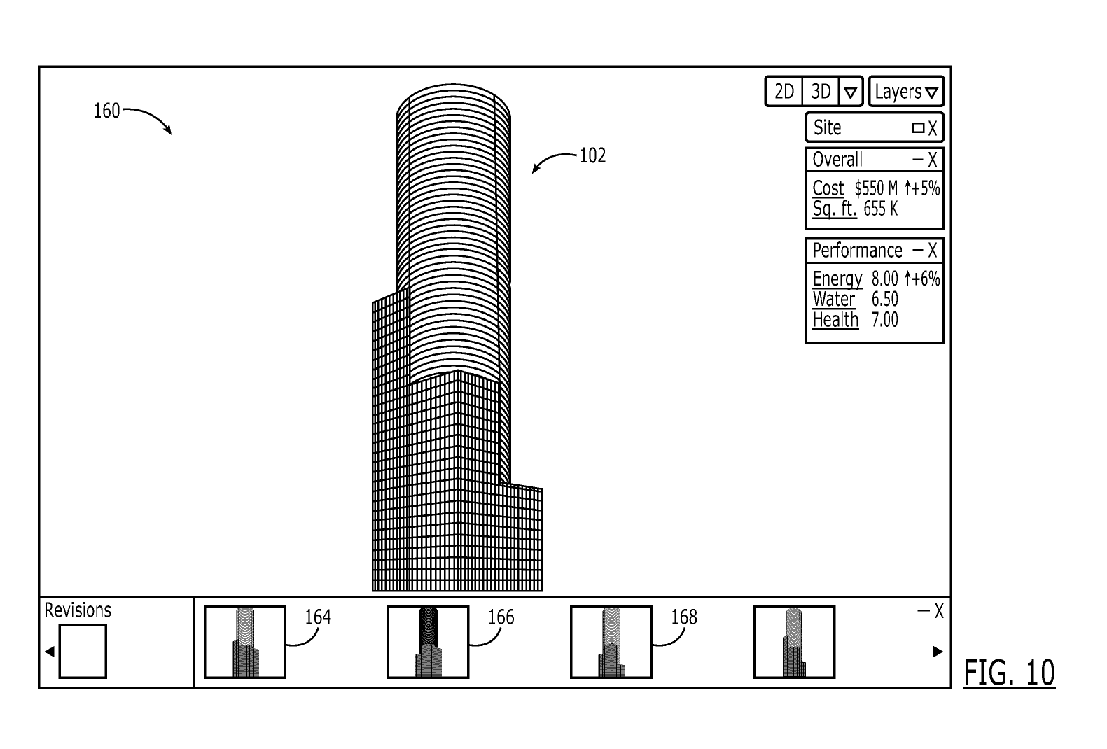

At any point in the design process a user (or the system, automatically) may save and annotate a revision. These revisions may be available to a user in an interface such as interface 160 shown in FIG. 10. For example, a user may save a version of the design, initiate an optimization, and then save the new design provided in response to the optimization. This allows the user to later compare the options, provide the options to a client for consideration, to an engineer for additional comparisons, to a builder for more refined bids and time estimates, and so on. The various revisions, such as 164, 166, 168, and so on can simply be selected from the revisions pane 162 in interface 160.

Returning to FIG. 2, design engine 52 is provided with an interface for communicating with a secondary analysis system 170. Examples of such secondary analysis systems include structural analysis software, environmental simulation software, other design systems, project management systems, supply chain management systems, document production systems, permitting and approval system, and so on.

In one example, secondary analysis system 170 is a structural analysis software system such as Autodesk Robot (usa.autodesk.com), LARSA 4D (www.larsausa.com), RISA (www.risatech.com), StruCalc (www.strucalc.com), etc. Design engine 52 is provide with the application programming interfaces, converters, etc., required to permit direct export of design data to such secondary analysis system 170. The design data provided by design engine 52 may be utilized by secondary analysis system 170 to determine the structural soundness of the design. Secondary analysis system 170 may then provide data permitting refinement of the design, by design engine 52, so as to better satisfy structural soundness requirements.

In addition to structural engineering software, other software packages can receive and analyze the design data and provide feedback to design engine 52 to permit refining a design. Other such examples include environmental certification, ADA compliance, geological modeling, and so on. Additional design packages may take the design data from design engine 52 and expand on that data to provide additional aspects of a design, such as a landscaping design, interior design, and so on. These additional aspects may be provided back to design engine 52 such that the rendering of the design in design workspace 60 includes these addition aspects of the design.

It will be appreciated that a system according to the present disclosure is well suited for collaborative structure development. In one embodiment, many elements of system 50 may reside in a “cloud”-computing environment, and the user interacts with the system via specific application software, a web browser, etc. Thus, numerous parties can provide input to the design and process of developing the structure. That is, parties may collaborate on the design, such several architects working together on a single design, an owner or developer providing design preferences, an interior designer working on the interior layout of the structure, a builder providing refinements relating to practicality of building the structure, or all such parties (and, of course, possibly other interested parties) working together. Appropriate revision control is provided, such as by techniques otherwise known in the art.

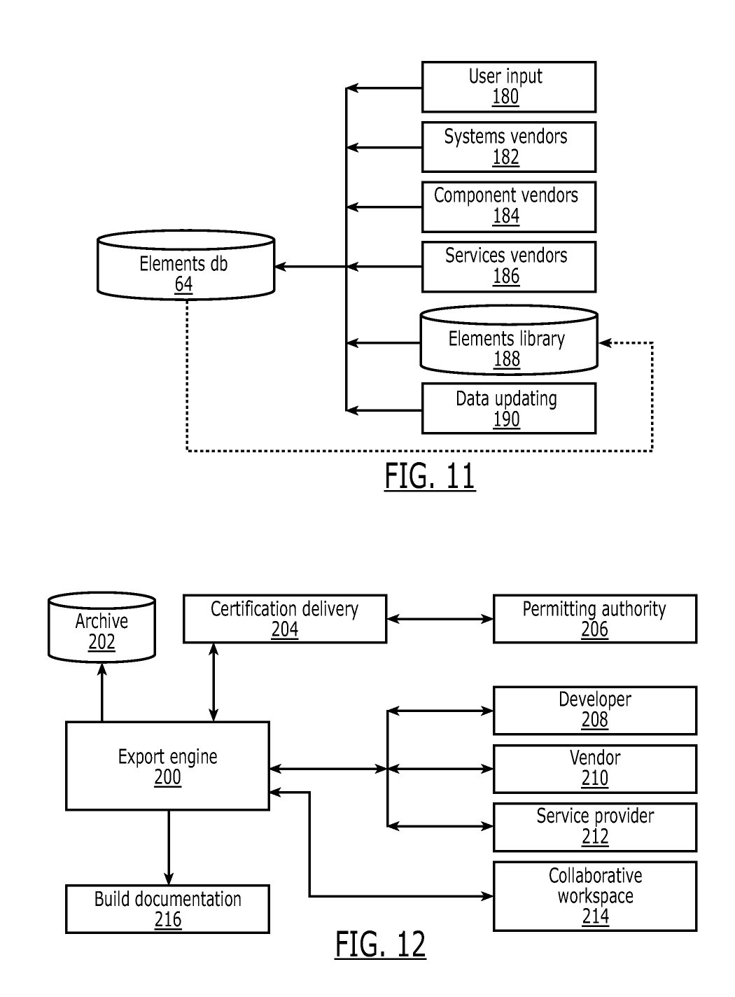

As previously mentioned, the elements such as systems and components in elements database 65 (FIG. 2) have been previously vetted. Information regarding the physical properties, cost, availability, and so forth for such elements has been factored into the database such that the elements may be readily incorporated into the design, and attributes such as cost, time-to-build, etc. can be calculated and presented to the user in dashboard 110. There are a number of ways to populate elements database 64, as illustrated in FIG. 11.

A first method is for the user to provide an element at 180, identifying a set of standard details about the element, such as dimensions, cost, source, availability, color or other option choices, etc. A form or template (not shown) may be used to assist the user in entering a complete and standardized set of details about the element being added to elements database 64. Another method is for system and component vendors to directly enter data at 182, 184 regarding the systems and components they supply, respectively. In this option, the vendors may be invited to enter these details, such as when a user identifies a system or component that they would like to incorporate into a design. Alternatively, the system may provide a portal through which systems and component vendors may apply to have their products included in the elements database by completing a form or template (not shown), and being vetted by an appropriate process, such as for dependability of vendor, quality of products supplied, reasonableness of price, and so on.

Similarly, elements database may contain data regarding services provided by a select group of service providers, entered at 186. Data relating to these service providers may be tied to systems and components, such as cost and time for installation of a specific type of tile per square foot, or the like. Or, data relating to these service providers may be independent of a specific product, such as cost and time to paint interior space per square foot regardless of the type, color, etc. of paint used. Again, the user may include these details based on knowledge the user collects about cost, time, quality, and so forth. Alternatively, the service providers may be invited to enter these details, such as when a user identifies a particular service provider that they would like to use in implementing the design (e.g., where the service provider has unique skills, special pricing, etc.) As another alternative, the system may provide a portal through which service providers may apply to be included in the elements database. A form or template (not shown) may be provided for completion by the user or service provider in order to standardize the data in elements database 64.

In one embodiment of the present disclosure, the systems and components vendors and service providers agree to be bound by the prices and delivery schedules that become part of elements database 64. Such agreement provides a degree of certainty to the attributes provided by dashboard 110 (FIG. 2), allowing the attributes so provided to be used, for example, to bid on the construction of the structure. Inevitably, however, things change. Thus, updating the prices, sources, availability, and so on is required and provided at 190. A portal (not shown) may be provided to permit the user, or the systems and components vendors and service providers to update pricing, availability, and so on. Automated updating may be provided, according to which the system checks published market rates for certain elements and updates elements database 64 accordingly. Commodity items such as lumber, standard steel beams, etc. can be managed in this way.

Another source of content for elements database is a library of previously vetted elements at 188. Indeed, once additional element data, system and component vendors and service providers, etc. are added to the elements database 64 for the current design, those new system and component vendors and service providers may be added into such a library for utilization in future designs. In the case that elements (and even parts of or complete designs) are reused from approved structures, their having been previously approved may provide advantages such as easier certifications and permitting.

Once a design has been created, and possibly edited, optimized, and so on, the design may be exported by export engine 200, as illustrated in FIG. 12. One simple export function is archiving of the design in an archive database 202. However, as previously discussed, the design produced by the system may be provided collaboratively developed with other parties, such as via a collaborative user interface or workspace 214. One such collaborator may be a party whose approval and certification may be required for the design to be implemented, such as a structural engineer whose certification of the design is a prerequisite for obtaining a construction permit. The interactive aspect of the system facilitates the design certification process for example to the point of receiving the certification within the system. The certification may then be provided by export engine 200 via a certification delivery mechanism 204 to the appropriate permitting authority 206.

Furthermore, upon completion of the design it may be desired to verify the cost, availability, and so forth of the specified systems, components, and services. Export engine 200 can provide the design or relevant portions thereof to the specified vendors 210 and service providers 212, and request confirmation of the commitments made. The system can also provide the final design details to the developer so that the developer can confirm that the design meets the developer's preferences, to facilitate the developer obtaining funding, to request final approval to proceed, and so on.

Upon receipt of permits and similar approvals, confirmation of price, availability, and so on from vendors and service providers, and authorization to proceed by the developer, the system may then produce the final build documentation at 216, set up a build time-line, place orders for systems and components, and attend to other details for entering the build phase of the project. An interface may be provided with essentially a “build” button, which ends the design phase and begins the build phase. The system may thereafter track changes to the design, cost and delivery changes, and other aspects of implementing the design, and provide a build dashboard, not shown, which can provide an estimate of attributes of the build phase such as cost, time-to-completion, and so on.

Upon implementing the build phase a number of notifications can be provided by the system. For example, purchase obligations for systems and components can be extended, service providers can be notified of the job, next steps in financing can be initiated, insurance, certification, and permitting authorities can be notified, and timelines prepared. It may therefore be appropriate to limit the ability to initiate the build phase in a way that prevents unintended commitments and inadvertent starting of a process not yet ready to be started, for example by requiring concurrent approval of the designer and construction manager, or other individuals or entities with sufficient authority.

While the disclosure has focused on the creation of a design utilizing cells, systems, components, etc. and facilitating the implementation of that design by coordinating the cost, availability, scheduling, and so forth of suppliers, service providers, etc., in one embodiment of the present disclosure, an entire design may be selected from a structure library 76 (FIG. 4) for a new selected site. That is, re-use of a design created for one site as the design for a different site. System 50 (FIG. 2) may then modify elements of that design for the new site, utilizing the aforementioned user program, external data, etc. The modification of the design may be relatively autonomous, or may be under user control, as previously described. Once the design is suitable for the site, the design may be optimized, edited, etc. again as previously described. Thus, a very high degree of reusability may be facilitated by a system according to the present disclosure, resulting in significant cost and time saving, recapturing of best-practices, improved efficiency, and so on.

While a plurality of preferred exemplary embodiments have been presented in the foregoing detailed description, it should be understood that a vast number of variations exist, and these preferred exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below.

Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A computer-implemented system for producing a structure design, comprising:
a design workspace in which a structure design can be rendered during a design process;
a requirements source containing a plurality of structure design requirement rules corresponding to at least one structure program;
a cell source for providing a definition of a cell for forming a portion of said structure design, said cell configured to be assembled together with other cells to form said structure design;
an interface for receiving a selection of a structure program;
a design engine communicatively coupled to said requirements source and said cell source, said design engine configured to:
identify a plurality of design requirement rules in response to selection of a structure program;
automatically select a plurality of cells from said cell source responsive to said identified plurality of design requirement rules; and
utilize a cell definition associated with each of said plurality of cells to automatically generate said structure design such that said structure design may be displayed in said design workspace;
an attributes engine which quantifies measures of various attributes of a structure based on said structure design during the process of generating said structure design; and
a dashboard interface coupled to said attributes engine for displaying said measures of various attributes of said structure during the process of generating said structure design.

2. The computer-implemented system of claim 1, further comprising an optimization engine for analyzing said structure design and definitions of cells comprising said design, and proposing alternatives to said design to said design engine which optimize features of said design.

3. The computer-implemented system of claim 2, further comprising a selection interface in which a user may select a design alternative proposed by said optimization engine to complete said design or as a basis for continuing designing of said structure.

4. The computer-implemented system of claim 3, in which said optimization engine optimizes said design based on said quantified measures of various attributes of the structure based on said structure design.

5. The computer-implemented system of claim 1, further comprising an export engine for exporting said design.

6. The computer-implemented system of claim 5, wherein said export engine provides notification to vendors and/or suppliers, as a function of cells forming said exported design, of said exported design.

7. The computer-implemented system of claim 5, wherein said export engine provides notification to a plurality of parties that the structure design is complete, and that steps should be taken in preparation for construction of a structure according to the design.

8. The computer-implemented system of claim 1, wherein said design engine is configured to receive data defining a structure perimeter, and generate, using said cell definition, at least one structure design for populating said structure perimeter.

9. The computer-implemented system of claim 8, further comprising an interface allowing a user to edit the structure perimeter and thereby cause said design engine to generate, using said cell definition, at least one alternative structure design for populating said structure perimeter.

10. The computer-implemented system of claim 1, wherein said cell source is a cell library consisting of a plurality of cell definitions, each cell definition representing a cell which may form a portion of a structure design, said cells configured to be assembled together to form a structure design.

11. The computer-implemented system of claim 10, wherein each said cell definition includes a size component, a shape component, a structural members component, and an interconnection component.

12. The computer-implemented system of claim 11, wherein said cell definition further includes a supplier identification component, an availability component, a cost component, a health component, and an environmental efficiency component.

13. The computer-implemented system of claim 10, further comprising a selection interface allowing a user to select a cell from said cell library and place said cell in said design workspace such that said design engine renders said cell as a part of said design, and said attributes engine updates said various measurements of the structure's attributes for display in said dashboard.

14. The computer-implemented system of claim 2, wherein said attributes engine compares at least one of said various attributes determined by said attributed engine to at least one corresponding target attribute and provides a score in said dashboard quantifying how said at least one determined attribute compares to said at least one target attribute.

15. The computer-implemented system of claim 14, further including a targets interface permitting a user to specify values for selected structure attributes, said specified values forming an input to said design engine.

16. The computer-implemented system of claim 14, wherein said optimization engine optimizes said design based on a user-selected preference for one attribute from a group of at least two selected structure attributes.

17. The computer-implemented system of claim 14, further comprising an interface for directing said optimization engine to weight optimization of one attribute greater than other attributes.

18. The computer-implemented system of claim 1, wherein said measures of a structure's attributes are selected from the group consisting of:
square footage, cost of completion, operational energy consumption, operational efficiency, time to completion, and health rating.

19. The computer-implemented system of claim 5, further comprising an interface to a secondary analysis system such that said design from said design engine may be utilized by said secondary analysis system to provide data associated with said design.

20. The computer-implemented system of claim 19, wherein said secondary analysis system is a structural engineering analysis system such that said design provided by said design engine may be utilized by said structural analysis system to determine structural soundness of said design, and to provide to said design engine data permitting refinement of said design so as to satisfy structural soundness requirements.

21. The computer-implemented system of claim 19, further comprising a certification delivery component, coupled to said export engine, for providing to resources external to said computer-implemented system a certification that said design satisfies requirements as determined by said secondary analysis system.

22. The computer-implemented system of claim 1, further comprising a database of external data coupled to said design engine, said design engine producing said structure design further based in part on said external data.

23. The computer-implemented system of claim 22, wherein said external data are selected from the group consisting of: topographic data for a site on which said structure is to be built, geologic data for the site on which said structure is to be built, climate data for the site on which said structure is to be built, design and building codes relating to the structure to be built, design and building practices relating to the structure to be built, zoning data, historical real estate data, neighborhood information, and physical form of neighboring structures.

24. The computer-implemented system of claim 1, wherein said design engine connects cells forming said design such that individual cells are not visible in said rendered design, but said design includes individual cell data allowing said design engine to modify said design on a cell-by-cell basis based on a user removing, adding or moving one or more cells in said design.

25. The computer-implemented system of claim 2, wherein said alternatives proposed by said optimization engine comprise proposed replacement of cells, removal of cells, addition of a cell, and reconfiguration of cells.

26. The computer-implemented system of claim 2, wherein said structure design comprises initial systems and components, and further wherein said alternatives proposed by said optimization engine comprise proposed replacement of at least one of said initial systems and components of the design, removal of at least one of said initial systems and components from the design, addition of at least one system or component to the design, and reconfiguration of at least one of said initial systems and components in the design.

27. The computer-implemented system of claim 25 or 26, wherein said design engine renders said alternatives to said design in said design workspace as they are proposed.

28. The computer-implemented system of claim 1, wherein said structure design comprises a plurality of cells, further comprising a user interface permitting a user to select multiple cells as a group and remove or rearrange said group.

29. The computer-implemented system of claim 1, further comprising a selection interface in which a user may specify an element of said design to be included in said design, such that said design engine does not alter or remove said specified element in the process of producing said structure design.

30. The computer-implemented system of claim 29, wherein said specified element is a cell.

31. The computer-implemented system of claim 29, wherein said specified element is a system or component.

32. The computer-implemented system of claim 2, further comprising a selection interface in which a user may specify an element of said design to be constrained such that said optimization engine does not alter or remove said specified element in the process of analyzing said structure design and definitions of cells comprising said design and proposing alternatives to said design to said design engine.

33. The computer-implemented system of claim 32, wherein said specified element is a cell.

34. The computer-implemented system of claim 32, wherein said specified element is a system or component.

35. The computer-implemented system of claim 2, further comprising a comparison interface providing a side-by-side comparison of more than one design attribute, and further providing a mechanism permitting a user to select one of said more than one design attributes to complete said design or as a basis for continuing designing of said structure.

36. The computer-implemented system of claim 35, wherein at least one of said design features is provided by said optimization engine.

37. The computer-implemented system of claim 1, further comprising an elements database providing data regarding systems and components to said design engine such that said systems and components may be included in said design produced by said design engine.

38. The computer-implemented system of claim 37, wherein said system determines a default location in said structure design for at least one system or component, and further comprising an interface permitting a user to override said default and reposition said at least one system or component in said design.

39. The computer-implemented system of claim 1, further comprising a structure program data source providing program data to said design engine such that said design engine produces said structure design based at least in part on said program data.

40. A computer-implemented system for producing a structure design, comprising:
a requirements database containing a set of structure design requirement rules corresponding to at least one structure program;
a cell and structure data database for providing definitions of cells forming a portion of said structure design;
an elements database for providing systems and components data;
an interface for receiving a selection of a structure program;
a design engine communicatively coupled to said requirements source, said cell source, and said elements database, said design engine configured to:
identify a plurality of design requirement rules in response to selection of a structure program;
automatically select a plurality of cells from said cell source responsive to said identified plurality of design requirement rules;
select a plurality of elements from said elements database responsive to selection of a structure program; and
utilize a cell definition associated with each of said selected cells and systems and components data associated with each said selected element to automatically generate said structure design such that said structure design may be displayed in said design workspace;
an optimization engine coupled to said design engine for receiving design data, analyzing said design data, and proposing alternatives to said design to said design engine which optimize features of said design;
an attributes engine which quantifies measures of various attributes of a structure based on said structure design during the process of designing said structure;
a dashboard for displaying said measures of various attributes of said structure during the process of designing said structure;
a design workspace and user interface coupled to said design engine in which said structure design can be rendered, and further in which said user may select elements for inclusion in or exclusion from said design, and still further in which a user may select between the design and alternatives provided by said optimization engine;
an interface coupled to said design engine permitting said design engine to communicate with a secondary analysis system such that said design may be utilized by said secondary analysis system to provide data associated with said design; and
an export engine coupled to said design engine for exporting a design provided by said design engine design.

41. The computer-implemented system of claim 40, in which said optimization engine optimizes said design based on said quantified measures of various attributes of the structure based on said structure design.

42. The computer-implemented system of claim 40, wherein said design engine is configured to produce a design based on said inputs without user intervention.

43. The computer-implemented system of claim 40, further comprising a certification delivery component, coupled to said export engine, for providing to resources external to said computer-implemented system a certification that said design satisfies requirements as determined by said secondary analysis system.

44. The computer-implemented system of claim 40, wherein said design engine renders said alternatives to said design in said design workspace as they are proposed.

45. The computer-implemented system of claim 40, wherein said exported design is a final design.

46. A computer-implemented method of producing a structure design, comprising:
providing an initial set of site data to a design engine;
providing a structure design program to said design engine, said structure design program having associated therewith a plurality of design requirements;
identifying a plurality of design requirement rules in response to selection of a structure program;
automatically instantiating a plurality of cells, responsive to said site data and said identified plurality of design requirement rules, each said identified cell having associated therewith a cell definition, to generate said structure design such that said structure design may be displayed in said design workspace;
quantifying, utilizing an attributes engine, measures of various attributes of a structure based on said structure design during the process of designing said structure;
displaying said structure design in a design workspace; and
displaying said measures of various attributes of said structure during the process of designing said structure in a dashboard interface.

47. The computer-implement method of claim 46, further comprising optimizing by analyzing, utilizing an optimization engine, said design and proposing modifications to said design that may form alternatives to optimize features of said design.

48. The computer-implement method of claim 47, further comprising:
providing said modifications to said design engine;
providing, by said design engine, alternatives to said design which optimize a feature of said design;
rendering said alternatives to said design in said design workspace; and
providing a user interface for selecting between said alternatives to said design provided by said optimization engine.

49. The computer-implement method of claim 48, wherein said optimized feature is an attribute quantified by said attributes engine.

50. The computer-implement method of claim 49, wherein said optimizing optimizes said design based on a user-input value for said attribute.

51. The computer-implement method of claim 48, further comprising receiving a user-selected preference for one attribute from a group of at least two selected structure attributes, and wherein said optimizing is based at least in part on said user-selected preference.

52. The computer-implement method of claim 48, further comprising specifying, utilizing a user interface, weighting values to weight optimization of one attribute greater than other attributes such that said optimizing is a function of said weighting values.

53. The computer-implement method of claim 48, further comprising receiving a user selection of an attribute of said structure design that is not to be modified by said design engine, and in response thereto said optimization engine does not alter or remove said specified element in the process of analyzing said design and proposing modifications to said design to said design engine.

54. The computer-implemented method of claim 53, wherein said specified element is a cell.

55. The computer-implemented method of claim 53, wherein said specified element is a system or component.

56. The computer-implement method of claim 46, wherein said initial set of site data includes structure perimeter data.

57. The computer-implement method of claim 56, further comprising editing, utilizing an editing interface, said structure perimeter data.

58. The computer-implement method of claim 47, further comprising providing a user-selected cell, utilizing a cell selection interface, to said design engine, and further wherein said design is further provided utilizing said user-selected cell.

59. The computer-implement method of claim 46, further comprising providing interfacing with a secondary analysis system such that said design from said design engine may be utilized by said secondary analysis system to provide data associated with said design.

60. The computer-implement method of claim 59, further comprising providing to resources external to said design engine a certification that said design satisfies requirements as determined by said secondary analysis system.

61. The computer-implement method of claim 46, further comprising providing external data to said design engine from an external data database, said design engine producing said structure design further based in part on said external data.

62. The computer-implement method of claim 61, wherein said external data are selected from the group consisting of: topographic data for a site on which said structure is to be built, geologic data for the site on which said structure is to be built, climate data for the site on which said structure is to be built, design and building codes relating to the structure to be built, design and building practices relating to the structure to be built, zoning data, historical real estate data, neighborhood information, and physical form of neighboring structures.

63. The computer-implement method of claim 46, further comprising providing data regarding systems and components, from an elements database, to said design engine such that said systems and components form a portion of said design produced by said design engine.

64. The computer-implement method of claim 63, further comprising receiving, by way of an interface to said elements database, system, component, and service data from vendors of systems and components and service providers, said design engine producing said structure design based in further part on said system, component, and service data.

65. The computer-implemented method of claim 46, further comprising exporting said structure design by an export engine for use by a system external to said design engine.

66. The computer-implemented method of claim 65, wherein said export engine provides notification to vendors and/or suppliers, as a function of systems and components forming said exported design, of said exported design.

67. The computer-implemented method of claim 65, wherein said export engine provides notification to a plurality of parties that the structure design is complete, and that steps should be taken in preparation for construction of a structure according to the design.

68. The computer-implemented method of claim 46, further comprising providing a program definition to said design engine such that said design is further provided, utilizing said design engine, from said program definition.

69. A non-transitory computer readable medium having computer program logic stored thereon executable on one or more processors for producing a structure design, the computer program logic comprising:
code for implementing a design workspace in which a structure design can be rendered during a design process;
code for implementing a requirements source containing a plurality of structure design requirement rules corresponding to at least one structure program;
code for implementing a cell source for providing a definition of a cell for forming a portion of said structure design, said cell configured to be assembled together with other cells to form said structure design;
code for implementing an interface for receiving a selection of a structure program;
code for implementing a design engine so as to be communicatively coupled to said requirements source and said cell source, said design engine configured to:
identify a plurality of design requirement rules in response to selection of a structure program;
automatically select a plurality of cells from said cell source responsive to said identified plurality of design requirement rules; and
utilize a cell definition associated with each of said plurality of cells to automatically generate said structure design such that said structure design may be displayed in said design workspace;
code for implementing an attributes engine which quantifies measures of various attributes of a structure based on said structure design during the process of generating said structure design; and
code for implementing a dashboard interface for displaying said measures of various attributes of said structure during the process of generating said structure design.

70. The non-transitory computer readable medium of claim 69, further comprising code for implementing an optimization engine for analyzing said structure design and definitions of cells comprising said design, and proposing alternatives to said design to said design engine which optimize features of said design.
